(19) United States
(12) Patent Application Publication
(10) Pub. No.: US 2024/0017104 A1
(43) Pub. Date: Jan. 18, 2024

(54) MOTOR VEHICLE EQUIPPED WITH A BATTERY PACK WITH FIRE EXTINGUISHING DEVICE

(71) Applicant: HUTCHINSON, Paris (FR)

(72) Inventors: Nicola MORETTI, Gassino Torinese (TO) (IT); Clément BRET, Torino (TO) (IT); Maurizio BAGNASCO, Moncalieri (TO) (IT); Eric BOSSARD, La Selle En Hermoy (FR); Christian LARROQUE, Pannes (FR)

(73) Assignee: HUTCHINSON, Paris (FR)

(21) Appl. No.: 18/350,930

(22) Filed: Jul. 12, 2023

(30) Foreign Application Priority Data
Jul. 13, 2022 (FR) 2207262

(51) Int. Cl. A62C 3/07; B60L 50/60

(52) U.S. Cl. CPC A62C 3/07; B60L 50/66

(57) ABSTRACT

A motor vehicle includes at least one battery pack for a motor vehicle. The battery pack includes a housing defining an internal cavity, rechargeable electric battery cells arranged in the internal cavity, and a fire extinguishing device housed in the internal cavity and having an elongated extinguishing pipe closed at both longitudinal ends. The extinguishing fluid includes a mixture of fluid and powder, and the housing includes at least one gas and/or smoke evacuation port, the at least one port being equipped with a movable flap.

### TECHNICAL FIELD OF THE INVENTION

This invention relates to the field of the extinguishing fire or of the limiting starting fire in a battery pack. The invention is particularly, but not exclusively, suitable for its use in the domain of the motor vehicles or machines equipped with one or more battery packs. These may be vehicles electrically powered or hybrid-powered, for example thermal, electric, hybrid or fuel cell.

### TECHNICAL BACKGROUND

A battery pack is an assembly of batteries or battery cells arranged side by side. The battery cells are preferably in a closed container. They are electrically connected to each other and to electrical terminals for the purpose of electrically recharging these cells and supplying power to electrical equipment such as an electric motor.

It is advantageous to equip a motor vehicle with a device for automatically extinguishing a fire or a starting fire. This device is generally autonomous in that it reacts directly to the heat generated by this fire or starting fire.

A number of solutions are currently available in the current technique, but they are not always feasible or, in particular, industrially viable.

Some solutions consist in using an extinguishing fluid storage container in the form of a bottle or cylinder. The disadvantage of these solutions is the overall dimension and the weight involved in using this type of container.

Other solutions use a simple extinguisher pipe, i.e., a pipe that contains a pressurised extinguishing fluid and whose ends are sealed, i.e., they are not connected to a storage container. In other words, the only volume of extinguishing fluid available is that stored in the extinguishing pipe.

The document WO-A1-91/08022 describes a fire extinguisher pipe of this type. The pipe is made of a thermoplastic material. In the event of a fire, the thermoplastic material softens, and the internal pressure causes the pipe to rupture at the hottest point, which is generally in line with the heat source, so that the extinguishing fluid escapes from the pipe and is applied directly to the source of the fire.

The present invention proposes at least one improvement on the current technique, which is simple, effective, and economical.

### SUMMARY OF THE INVENTION

The invention proposes a motor vehicle comprising at least one battery pack, this battery pack comprising:
a housing defining an internal cavity;
rechargeable electric battery cells arranged in the internal cavity, and
a fire extinguishing device housed in the internal cavity and made of a meltable thermoplastic material, this device containing a pressurised extinguishing fluid intended to be released by melting of said material in the event of a fire or starting fire in the internal cavity,
characterised in that the extinguishing fluid comprises a mixture of fluid and powder, and in that the housing comprises at least one port for evacuating the gas and/or smoke, said at least one port being equipped with a flap movable between a first position for closing the port and a second position for opening the port and evacuating the gas and/or the smoke, the flap of the or each port being configured to move from its first to its second position, in particular by the pressure generated, when the mixture of gas and powder is released, and said at least one port comprising an outlet oriented on at least one side of the vehicle.

One of the characteristics of the invention concerns the mixture used for the fire extinguishing. This mixture comprises a fluid, such as a gas or a liquid (for example a pressurised gas in liquid form), and a powder. This mixture is advantageous in that the fluid and the powder have two distinct functions which are combined. The function of the powder is to cover the flames and smother them so as to deprive them of oxygen. The function of the fluid is to evacuate the smoke and/or the gases generated by the fire, the starting fire, or its extinction by powder.

Another characteristic of the invention relates to the housing of the battery pack, which comprises one or more evacuation ports with flap or poppet. The gas released by the device can escape through these ports to prevent an overpressure in the cavity. As the gas escapes through the ports, the gas conveys with it the aforementioned smokes, which are then expelled outside the battery pack. This allows the smoke and/or the gases generated by the fire or the starting fire to be quickly evacuated from the battery pack. There is therefore less risk of these smokes entering the passenger compartment of the vehicle equipped with the battery pack and causing discomfort or poisoning to its occupants.

The outlet of the or each port is oriented on at least one side of the vehicle, i.e., on a right side, on a left side (e.g., driver's side) or on both right and left sides of the vehicle.

The battery pack according to the invention may comprise one or more of the following characteristics, taken in isolation from each other or in combination with each other:
the extinguishing fluid is in gaseous state.
the housing comprises at least two ports, each equipped with a movable flap;
the housing is generally parallelepipedic in shape and comprises two walls, a front wall and a rear wall, and two lateral walls, the ports being located on one of the front and rear walls;
the ports are spaced apart and located close to the lateral walls;
the device comprises at least one pipe;
the device or the pipe is elongated and may have bypasses;
the device or the pipe is closed at both longitudinal ends;
the device or the pipe is generally U-, L- or S-shaped;
the device is in the form of a pipe comprising two lateral branches which extend into the cavity along said lateral walls, and at least one median or transverse branch which extends into the cavity, for example along one of the front and rear walls which is opposite said ports;
the ports each comprise or form an elbow, the elbows of the ports comprising inlets connected to the cavity and outlets, the outlets of the two ports facing in opposite directions on two opposite sides of the vehicle;
the elbow is L-shaped or right-angled;
the extinguishing fluid comprises a mixture of gas and powder;
the battery pack comprises at least one pressure sensor configured to measure the pressure of said fluid in the device or the pipe;
said at least one sensor is connected to remote communication means, for example for communicating with elements of the vehicle;
the flap of the or each port is configured to move from its first to its second position when the internal cavity reaches a pressure greater than or equal to 1.1 bar; the lower this value, while remaining greater than atmospheric pressure, the lower the risk of overpressure in the cavity;
said mixture comprises between 30 and 80% by volume of powder and the remainder of fluid;
said powder is of the ABC type;
said powder comprises ammonium sulphate and salt, or phosphate and traces of sodium bicarbonate;
the battery pack is installed horizontally on the chassis or is integrated into the chassis of the vehicle;
the battery pack extends between the wheels and from one side of the vehicle to the other;
said powder comprises sodium and potassium chloride;
the fluid comprises a single fluid or a mixture of fluids;
the extinguishing fluid is in the liquid state and has a boiling temperature greater than or equal to 70° C., and preferably greater than or equal to 120° C.,
the extinguishing fluid has a PRP or PRG equal to or less than 5000;
the extinguishing fluid comprises at least one HFC gas and/or C₆F₁₂O and/or CO₂;
the extinguishing fluid comprises nitrogen, preferably mainly nitrogen;
said HFC gas is selected from R227ea and R125;
the device or the pipe comprises a fluorinated thermoplastic material or EVOH;
the device or the pipe has a permeability to said extinguishing fluid of less than or equal to 1 cm³·25 μm/m²·atm·24 h;
the device or the pipe is preformed by thermoforming to adopt a shape corresponding to that in a desired position for installation in the battery pack;
the device or the pipe comprises a first layer in a fluorinated thermoplastic material or EVOH and a second layer in a polyamide thermoplastic material;
the extinguishing fluid may be liquid or gaseous at atmospheric pressure and ambient temperature; advantageously, it is gaseous when it is intended to extinguish a fire or starting fire; it may therefore be liquid at atmospheric pressure and at ambient temperature and become gaseous at a temperature greater than or equal to 50° C., for example, as is the case with C₆F₁₂O;
said longitudinal ends are sealed by plugs which are fitted and attached, for example by press-fitting or welding;
the device or the pipe comprises a fluid inlet and/or evacuation port, for example at a first of its longitudinal ends;
the device or the pipe comprises a fluid inlet and/or evacuation port, for example at a second of its longitudinal ends;
a fluid inlet and/or evacuation port is located at a distance from the longitudinal ends of the device or the pipe;
the or each port of the device or of the pipe comprises a poppet valve, this valve comprising a poppet which is biased by a resilient member into a sealed closed position of the device or of the pipe, and which is movable from this closed position to an open position when a fluid supply the device or the pipe through the port and has a pressure greater than that of the pressure in the device or the pipe;
the fluid is contained in the pipe at a pressure of between 5 and 20 bar, and preferably between 10 and 12 bar.

### BRIEF DESCRIPTION OF THE FIGURES

The invention will be better understood and other details, characteristics and advantages of the present invention will become clearer from the following description made by way of non-limiting example and with reference to the attached drawings, in which:

FIG. 1 is a schematic perspective view of a vehicle chassis equipped with a battery pack,

FIG. 2 is a schematic perspective view of a battery pack,

FIG. 3 is a schematic perspective view of a battery pack according to one embodiment of the invention,

FIG. 4 is a similar view to FIG. 4 and illustrates an operating stage of the extinguishing device with the appearance of a fire in the housing of the battery pack,

FIG. 5 is a similar view to FIG. 4 and illustrates a further stage in the operation of the extinguishing device with the breaking of the extinguishing device and the release of the mixture contained therein,

FIGS. 6a to 6c are schematic cross-sectional views of poppet ports for a battery pack according to the invention,

FIG. 7 is a schematic perspective view of a battery pack according to an alternative embodiment of the invention,

FIG. 8 is a schematic perspective view of a battery pack according to another alternative embodiment of the invention, and

FIG. 9 is a schematic perspective view of a battery pack according to another alternative embodiment of the invention.

### DETAILED DESCRIPTION OF THE INVENTION

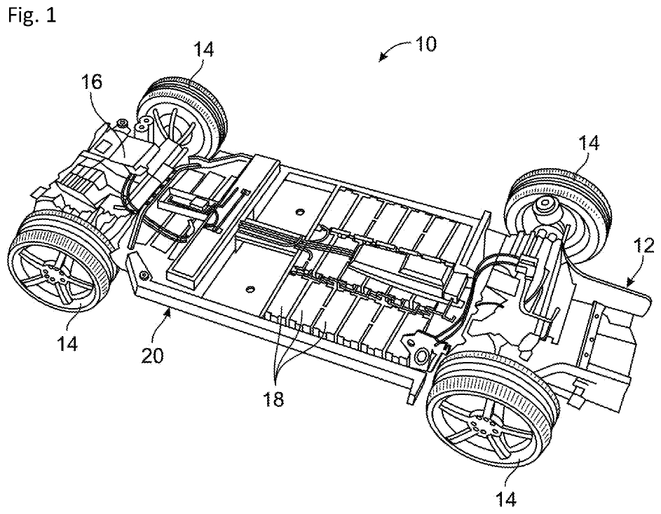

FIG. 1 shows a portion of a vehicle 10, in particular a car. FIG. 1 shows the chassis 12 of this vehicle 10 and its four wheels 14. The vehicle 10 is equipped with an electric motor 16 which is supplied with electricity by batteries or battery cells 18 which form part of an assembly referred to as a “battery pack” 20.

The battery pack 20 of a vehicle 10 is generally relatively large and is installed horizontally on the chassis 12 of the vehicle 10. As in the example shown, the battery pack 20 can extend between and close to the wheels 14 and can extend from one side of the vehicle 10 to the other.

Alternatively, the battery pack 20 could be integrated into the chassis 12 to form a battery pack of the CTC type, which stands for Cell To Chassis.

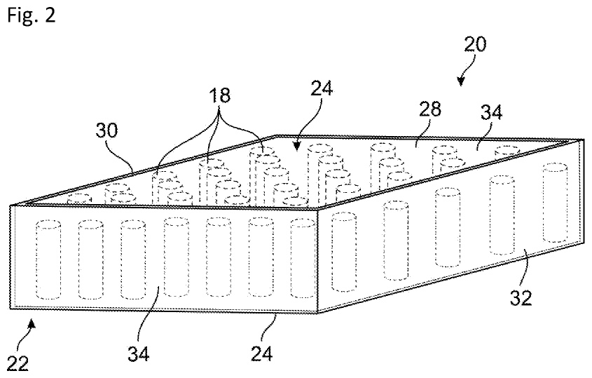

FIG. 2 shows a schematic diagram of a battery pack 20 of this type. The battery pack 20 essentially comprises a housing 22 defining an internal cavity 24 for housing a plurality of rechargeable electric battery cells 18 which are arranged side by side.

In the example shown, which is not limiting, the housing 22 has a generally parallelepiped shape and comprises a lower wall forming a bottom 26, an upper wall forming a cover 28, and lateral walls 30, 32, 34. The walls 30 and 32 are front and rear walls located respectively towards the front and towards the rear of the vehicle 10 (see FIG. 1). The walls 34 are lateral walls and are therefore located on the sides of the vehicle 10 (see FIG. 1).

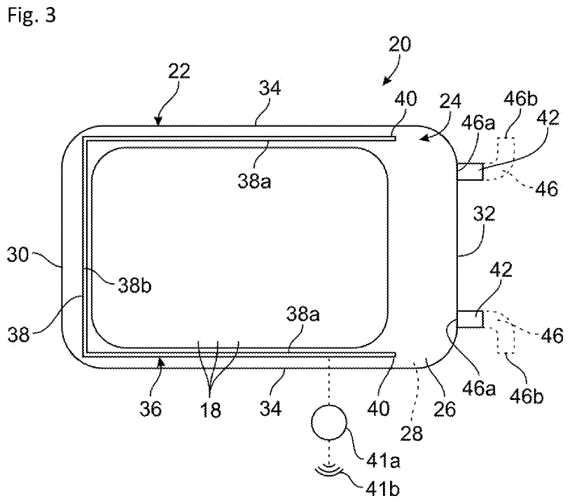

FIG. 3 illustrates an embodiment of the invention and shows a battery pack 20, the housing 22 of which contains battery cells 18 and a fire extinguishing device 36 in its cavity 24.

In the example shown, the housing 22 has a generally parallelepiped shape and comprises a lower wall forming a bottom 26, an upper wall forming a cover 28, and lateral walls 30, 32, 34. The walls 30 and 32 are front and rear walls located respectively towards the front and towards the rear of the vehicle 10. The walls 34 are lateral walls and therefore located on the sides of the vehicle 10.

The bottom 26 or the cover 28 has a surface area of 3000 cm² or more, for example.

For example, the cavity 24 has a volume V1 greater than or equal to 1 L, and for example greater than or equal to 50 L.

The number of cells 18 in a pack is for example greater than or equal to 10, and for example greater than or equal to 50.

The cells 18 occupy a volume V2 of the cavity 14 representing at least 50% of V1.

The cells 18 can each be generally prismatic, cylindrical or pocket-shaped.

The extinguishing device 36 is preferably in the form of a pipe 38 containing a pressurised extinguishing fluid. This pipe 38 may have bypasses or ramifications. Alternatively, the device 36 could be in the form of a pocket, for example, which would be housed in the cavity 24 of the housing 22, and for example integrated into a wall of the housing 22.

In the example shown, the pipe 38 has a generally elongated shape and its two longitudinal ends 40 are sealed, for example by plugs.

The pipe 38 is generally U-shaped and comprises two lateral branches 38a which extend into the cavity 24 along the lateral walls 34 of the housing 22, and a median branch 38b which extends into the cavity 24 along one of the walls 30, 32, for example the front wall 30 in the example shown.

The length of the pipe 38 can be between 50 cm and 5 m. By way of example, the pipe 38 has an external diameter of between 10 and 30 mm, and preferably between 10 and 20 mm. The pipe 38 has a wall thickness of between 1 and 3 mm, and preferably between 1 and 2 mm.

Each plug can be press-fitted into one of the longitudinal ends 40 of the pipe 38. Alternatively, it could be welded by ultrasound, for example. Each plug can be equipped with a fluid inlet and/or evacuation port, preferably comprising a poppet valve.

The wall of the pipe 38 may be single-layer or multi-layer. For example, it may comprise two layers, internal and external, respectively.

The internal layer can be made of a material with a low permeability relative to the extinguishing fluid, i.e., a permeability of less than or equal to 1 cm³·25 μm/m²·atm·24 h. For example, it is made of a fluorinated thermoplastic material or EVOH.

The external layer is made from a polyamide thermoplastic material, which generally has a higher permeability than the internal layer, for example greater than or equal to 1 cm³·25 μm/m²·atm·24 h.

It is preferable for the lower permeability layer to be located inside the higher permeability layer. Otherwise, there would be a risk of migration of the gas through the more permeable internal layer and of stagnation of this gas at the interface between the two layers, which could lead to a delamination of the layers.

It is also advantageous to make the pipe in two layers rather than a single layer of low-permeability material, because this material is relatively expensive. To ensure a sufficient resistance, particularly to pressure, a single-layer pipe should have a high thickness of low-permeability layer. In the case of a two-layer or multi-layer pipe, this resistance is provided by the layer or the layers with the highest permeability, and the layer with the lowest permeability may have a relatively low thickness, sufficient to ensure the required impermeability.

The low-permeability layer could be arranged between two layers. This configuration allows to improve the mechanical strength of the layer during the forming stage of the pipe (and thus avoid any risk of tearing of this layer), while guaranteeing an optimum sealing of the pipe.

At least one of the materials of the wall is fusible under the effect of the heat generated by a fire or a starting fire, and in particular under the effect of a temperature greater than or equal to 70° C., or even 120° C.

In the example described above, both layers have such a fusible property.

The extinguishing fluid can be stored in the pipe 38 at a pressure of 10 bar or more, preferably 20 bar or more, and more preferably 30 bar or more.

The battery pack 20, the device 36 or the pipe 38 can be equipped with a pressure sensor 41a for measuring the pressure of the extinguishing fluid. This pressure sensor 41a is advantageously connected to remote communication means 41b of the RFID or radio type, for example. During a maintenance operation on the vehicle, for example, an operator can use a suitable equipment to read the pressure in the pipe 38 by simply passing this equipment close to an RFID tag or a radio transmitter arranged on the pipe 38.

In a preferred alternative embodiment, the remote communication means cooperate with elements of the vehicle to alert the driver of the vehicle in the event of an anomaly. This is the case, for example, when the pressure in the cavity is too low for the pipe to be operational and be able to extinguish a fire or starting fire. In this case, the driver of the vehicle could be alerted by a light on the dashboard indicating that the pipe has a fault and needs to be serviced, either by replacing it or refilling it with fluid at the correct pressure. In such a case, the electronics of the vehicle could be configured to put the vehicle in shutdown or degraded mode, discouraging the driver from using the vehicle, until the pipe undergoes this maintenance operation.

Alternatively, the above-mentioned vehicle elements could be connected to the pressure sensor 41a by a wire link.

According to a first characteristic of the invention, it is a mixture which is contained inside the pipe 38 and which is intended to be released by melting the wall of the pipe 38. The mixture comprises a pressurised fluid, in particular a pressurised gas, and a powder.

The mixture preferably comprises between 30 and 80% by volume of powder, the remainder of the volume of the mixture being occupied by the fluid.

The advantage of using this mixture is that it allows to combine the functions of its two components, i.e., the flame-smothering function by the powder and the smoke-evacuation function by the pressurised gas.

The fluid or the gas may comprise a single fluid or gas or a mixture of fluids or gases.

The gas preferably has a PRP or PRG equal to or less than 5000. The fluid may comprise at least one HFC gas and/or C₆F₁₂O and/or CO₂. Among the HFC gases that can be used, R227ea and R125 are preferred because they have a PRP or PRG of around 3400-3500. The DuPont company, for example, markets gases of this type under the names FE-25 and FM-200.

CO₂ is advantageous because it has a PRP or PRG of 1.

Finally, C₆F₁₂O is also advantageous because it has a PRP or PRG of 1. The 3M company markets this type of gas under the name Novec 1230 (FK-5-1-12).

The powder is, for example, a powder of the ABC type, i.e., a powder suitable for extinguishing class A, B and C fires. This type of powder generally comprises ammonium sulphate and salt, but also phosphate and traces of sodium bicarbonate. The ammonium salt melts under the effect of the heat and forms an insulating layer allowing to isolate the fuel from the oxidant (oxygen). The powder may comprise sodium and potassium chloride in addition or instead.

According to another characteristic of the invention, the housing 22 comprises at least one gas and/or smoke evacuation port 42, as shown in FIG. 3.

In the example shown, the housing 22 comprises two ports 42. These ports 42 are located on one of the walls of the housing 22, in this case on the rear wall 32. The ports 42 are spaced apart and located close to the lateral walls 34.

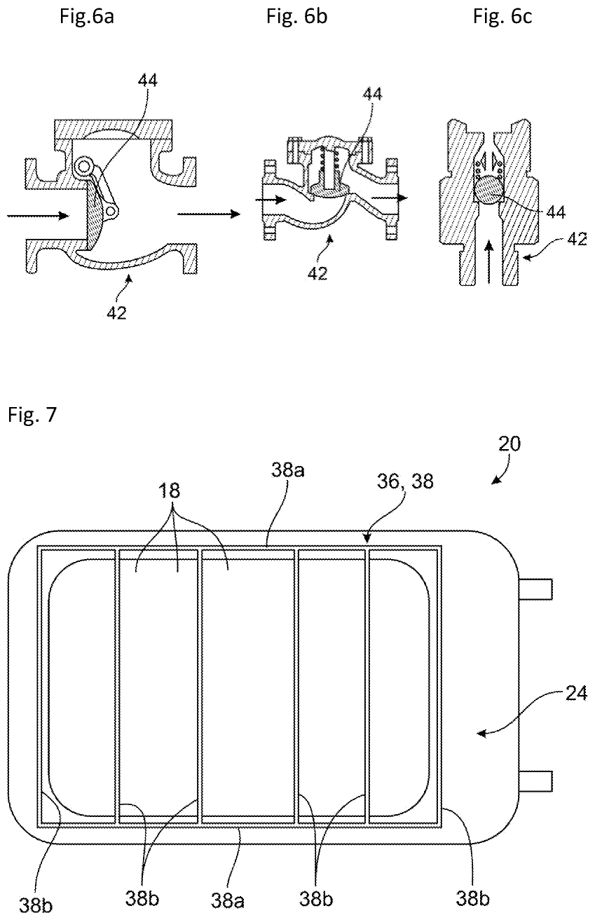

Advantageously, each of the ports 42 is equipped with a flap 44 which can be moved between a first position in which the port is closed and a second position in which the port is open and gas and/or smoke can be evacuated (see FIGS. 6a-6c). The flap 44 of the or each port 42 is configured to move from its first to its second position when the mixture of gas and powder is released.

FIGS. 6a to 6c show several possible but non-limiting configurations of a port 42 equipped with a movable flap 44—this flap 44 being shown here in its closed position. The pressurised gas released by the ruptured pipe is sufficient to cause the flap 44 to move from its first position to its second position.

The flap 44 of each port 42 is preferably configured to move from its first to its second position when the cavity 24 reaches a pressure greater than or equal to 1.1 bar, which corresponds to an overpressure of 0.1 bar.

In addition, each of the ports 42 comprises or forms an elbow 46, as schematically illustrated in dotted lines in FIG. 3. The elbows 46 in the ports 42 comprise inlets 46a connected to the cavity 24 and outlets 46b facing in opposite directions, advantageously to the sides of the vehicle 10.

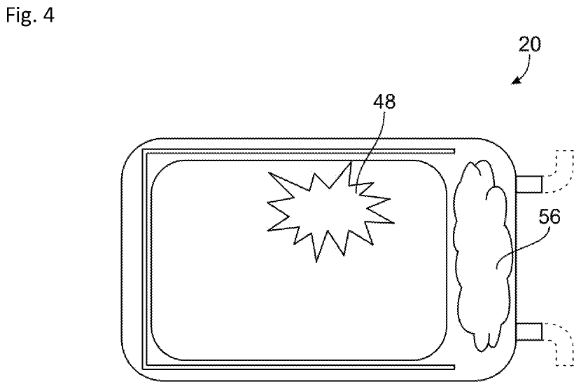

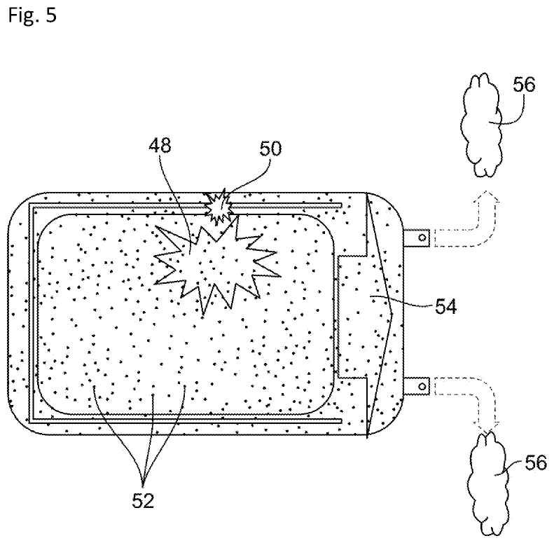

FIGS. 4 and 5 show the operating stages when a fire 48 or a starting fire appears in the battery pack 20. The fire causes the pipe 38 to heat up and, once it reaches a certain temperature, for example above 70 or even 120° C., it melts and ruptures in 50 as a result of the pressure inside the pipe 38. The mixture of powder and extinguishing fluid is then released. The powder 52 is dispersed in the cavity 24 and covers the fire 48, allowing it to be smothered and extinguished. The gas 54 is vaporised in the cavity 24 and escapes through the ports 42, conveying with it the smoke and/or the gases 56 generated by the fire and its extinction. The flaps 44 then move from their closed positions to their open positions to allow the pressurised gas and the smokes to pass through. Advantageously, these smokes 56 are expelled to the sides of the vehicle 10, as shown in FIG. 5, which prevents these smokes from entering the passenger compartment of the vehicle.

FIG. 7 illustrates an alternative embodiment of the invention which differs from the first embodiment in that the pipe 38 of the device 36 has a more complex shape and has several median/transversal ramifications or branches 38b.

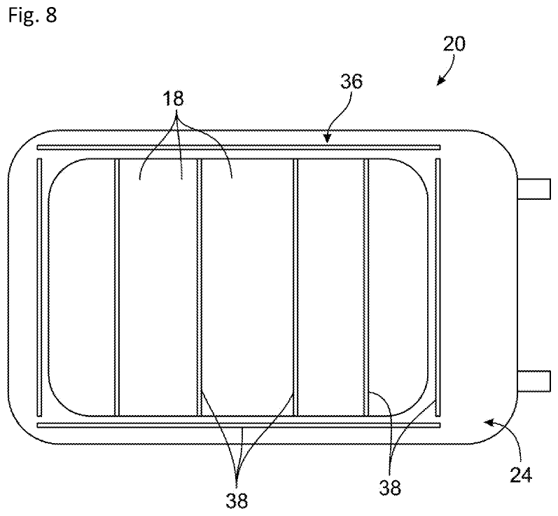

FIG. 8 illustrates another alternative embodiment of the invention which differs from the previous embodiment in that the device 36 comprises several independent pipes 38 arranged inside the cavity 24 of the battery pack 20.

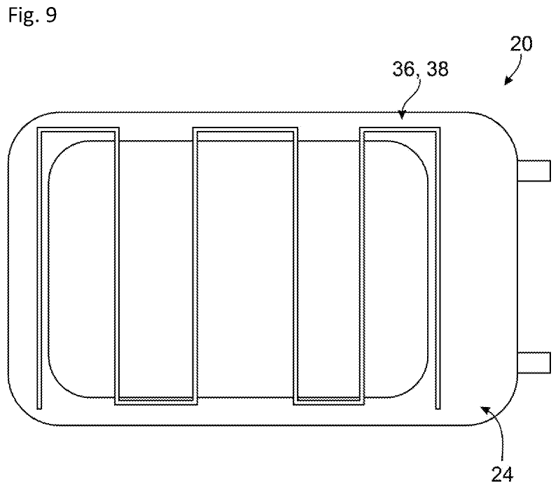

FIG. 9 illustrates another alternative embodiment of the invention which differs from the first embodiment in that the pipe 38 of the device 36 has a generally elongated S shape and snakes inside the cavity 24 of the battery pack 20.

1. A motor vehicle, comprising at least one battery pack, the battery pack comprising:
a housing defining an internal cavity;
rechargeable electric battery cells arranged in the internal cavity, and a fire extinguishing device housed in the internal cavity and made of a meltable thermoplastic material, the device containing a pressurised extinguishing fluid to be released by melting of said material in the event of a fire or starting fire in the internal cavity,
wherein the extinguishing fluid comprises a mixture of fluid and powder, and wherein the housing comprises at least one port for evacuating the gas and/or smoke, said at least one port being equipped with a flap movable between a first position for closing the port and a second position for opening the port and evacuating the gas and/or the smoke, the flap of the at least one port being configured to move from the first position to the second position by pressure generated when the mixture of fluid and powder is released, and said at least one port comprising an outlet facing at least one side of the vehicle.

2. The motor vehicle according to claim 1, wherein the housing comprises at least two ports each equipped with a movable flap.

3. The motor vehicle as claimed in claim 2, wherein the housing is generally parallelepipedic in shape and comprises a front wall and a rear wall, and two lateral walls, the ports being located on one of the front and rear walls.

4. The motor vehicle according to claim 3, wherein the ports are spaced apart and located proximate the lateral walls.

5. The motor vehicle according to claim 3, wherein the device comprises a pipe comprising two lateral branches which extend into the cavity along said lateral walls, and at least one median or transverse branch which extends into the cavity.

6. The motor vehicle according to claim 2, wherein the ports each comprise or form an elbow, the elbows of the ports comprising inlets connected to the cavity and outlets, the outlets of the two ports facing in opposite directions on two opposite sides of the vehicle.

7. The motor vehicle as claimed in claim 6, wherein the elbow is L-shaped or right-angled.

8. The motor vehicle according to claim 1, wherein the extinguishing fluid comprises a mixture of gas and powder.

9. The motor vehicle according to claim 1, further comprising at least one pressure sensor configured to measure pressure of said fluid in the device.

10. The motor vehicle according to claim 9, wherein said at least one sensor is connected to remote communication means.

11. The motor vehicle according to claim 1, wherein the flap of the at least one port is configured to move from the first position to the second position when the internal cavity reaches a pressure greater than or equal to 1.1 bar.

12. The motor vehicle according to claim 1, wherein said mixture comprises between 30% and 80% by volume of powder and the remainder fluid.

13. The motor vehicle according to claim 1, wherein the powder comprises ammonium sulphate and salt and/or sodium and potassium chloride.

14. The motor vehicle according to claim 1, wherein the battery pack is installed horizontally on the chassis of the vehicle or is integrated into the chassis of the vehicle.

15. The motor vehicle according to claim 1, wherein the battery pack extends between vehicle wheels and from one side of the vehicle to the other.

16. The motor vehicle according to claim 3, wherein the device comprises a pipe comprising two lateral branches which extend into the cavity along said lateral walls, and at least one median or transverse branch which extends into the cavity along one of the front and rear walls which is opposite said ports.

17. The motor vehicle according to claim 1, wherein said at least one sensor is connected to remote communication means for communicating with elements of the vehicle.
